(19) United States
(12) Patent Application Publication
(10) Pub. No.: US 2008/0114591 A1
(43) Pub. Date: May 15, 2008

(54) METHOD AND APPARATUS FOR EFFICIENTLY TEXT MESSAGING USING A WIRELESS MOBILE DEVICE

(76) Inventor: Robert Vernon Williamson, Austin, TX (US)

Correspondence Address: IBM CORP (YA);C/O YEE & ASSOCIATES PC, P.O. BOX 802333, DALLAS, TX, 75380, US

(21) Appl. No.: 11/559,714

(22) Filed: Nov. 14, 2006

(51) Int. Cl. G06F 17/21

(52) U.S. Cl. 704/10; 704/1

(57) ABSTRACT

The illustrative embodiments provide a method and an apparatus for writing a shortened text message using a wireless mobile device. An editor receives longhand text written through a user interface for the wireless mobile device. The editor then matches the longhand text with at least one shortened equivalent. A user interface then displays the at least one shortened equivalent. Responsive to receiving a user input accepting the at least one shortened equivalent through the user interface, the editor replaces the longhand text in a message with the at least one shortened equivalent.

### BACKGROUND OF THE INVENTION

1. Field of the Invention

The present invention relates generally to data communication using a wireless mobile device. More specifically, the present invention relates to a method and an apparatus for writing a shortened text message using a wireless mobile device.

2. Description of the Related Art

Typically, a wireless mobile company provides text messaging services at a particular rate. The rate is usually based on the number of text messages a user receives or transmits over a certain period of time. Typically, each text message is limited to a certain number of characters. If a text message exceeds the character threshold, the wireless mobile company may either split the text message into two or more messages or request that the user reduce the size of the message. If the wireless mobile company splits the text message into multiple messages, the user is separately charged for each text message.

As a result, in order to minimize cost and increase efficiency, users tend to shorten individual words by using contractions or commonly known abbreviations or symbols that represent a word or a group of words. In some cases, users phonetically spell a word to shorten the word. For example, users sometimes use the letter “u” to represent the word “you”, or the letters “u r” to represent the phrase “you are”.

However, in order to type a text message using the shortened form of the words, users often have to rely on their own memory for the shortened form. Additionally, users do not have a mechanism for recording additional new shortened forms that a user may receive in a message from another user. Furthermore, a system for predicting a shortened form does not currently exist. Although current systems exist that anticipate the end of an entire word, a system that anticipates an entire word and then presents a shortened form does not presently exist.

### SUMMARY OF THE INVENTION

The illustrative embodiments provide a method and an apparatus for writing a shortened text message using a wireless mobile device. An editor receives longhand text written through a user interface for the wireless mobile device. The editor then matches the longhand text with at least one shortened equivalent. A user interface then displays the at least one shortened equivalent. Responsive to receiving a user input accepting the at least one shortened equivalent through the user interface, the editor replaces the longhand text in a message with the at least one shortened equivalent.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 illustrates a wireless mobile device, in which an illustrative embodiment may be implemented;

FIG. 2 is a block diagram of a wireless mobile device, in which an illustrative embodiment may be implemented;

FIG. 3 is a block diagram of a text messaging system of a wireless mobile device, in accordance with an illustrative embodiment;

FIG. 4 illustrates an example of a database, in accordance with an illustrative embodiment; and

FIG. 5 is a flowchart illustrating the process of writing a shortened text message, in accordance with an illustrative embodiment.

### DETAILED DESCRIPTION OF THE PREFERRED EMBODIMENT

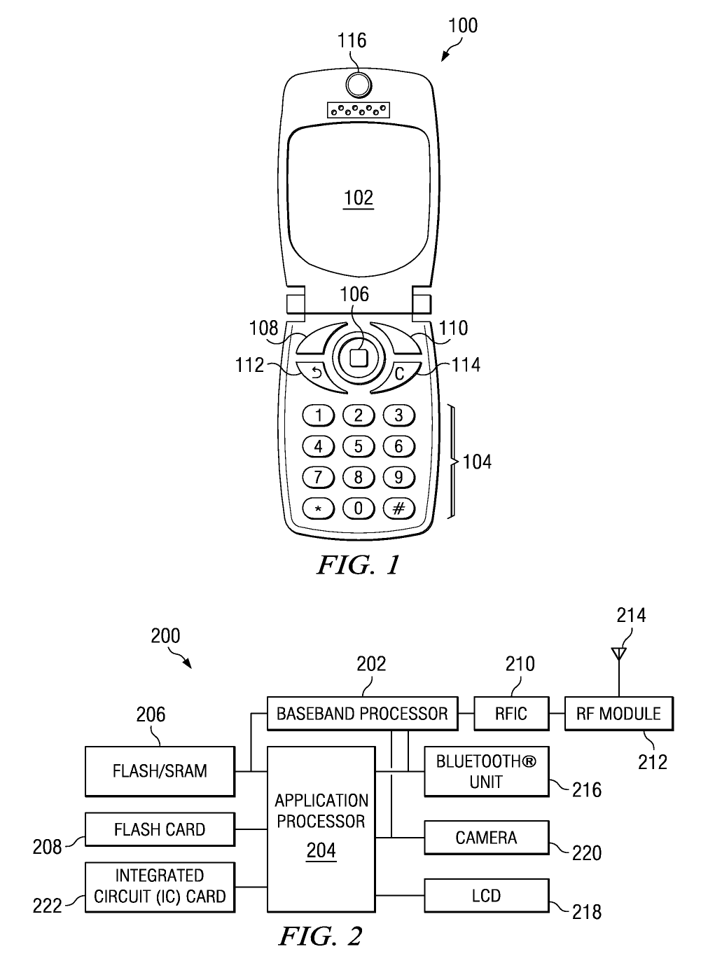

With reference now to the figures and in particular with reference to FIG. 1, a wireless mobile device is depicted in which an illustrative embodiment may be implemented. In the illustrative embodiment, wireless mobile device 100 is a mobile phone. However, in other embodiments, wireless mobile device 100 may also be a personal digital assistant (PDA). Wireless mobile device 100 includes screen 102, which is capable of displaying pictures and text. Additionally, wireless mobile device 100 also includes numeric keypad 104, joystick 106, and buttons 108, 110, 112, and 114 placed around joystick 106. Buttons 108, 110, 112, and 114 are used to initiate various functions in wireless mobile device 100. The functions include, for example, activating a menu, displaying a calendar, or initiating a call. Wireless mobile device 100 also includes camera 116 that is used to take pictures or videos, depending on the implementation.

FIG. 2 is a block diagram of a wireless mobile device, in which an illustrative embodiment may be implemented. Wireless mobile device 200 is similar to wireless mobile device 100 of FIG. 1. Wireless mobile device 200 includes baseband processor 202, application processor 204, flash/static random access memory (SRAM) 206, flash card 208, radio frequency integrated circuit (RFIC) 210, radio frequency (RF) module 212, antenna 214, Bluetooth® unit 216, liquid crystal display (LCD) 218, camera 220, and integrated circuit (IC) card 222.

Baseband processor 202 provides receiver and transmitter operations and is typically known as a transceiver. Baseband processor 202 handles the audio, signal, and data processing requirements needed to receive and send data using radio frequency (RF) or Bluetooth® transmissions. (Bluetooth® is a trademark of Bluetooth SIG, Inc. in the United States, other countries, or both.)

Application processor 204 provides the processing power for other functions, such as calculators, calendars, alarms, camera functions, and directories, within wireless mobile device 200. Flash/SRAM 206 is a storage device that stores various instructions and upgrades for the functions within wireless mobile device 200. Flash card 208 is a storage device in which user data and applications may be stored. An example of flash card 208 is a secure digital card.

Radio frequency integrated circuit (RFIC) 210 is a pathway for voice transmissions and other types of data. Additionally, Bluetooth® unit 216 sends and receives short range transmissions. Bluetooth® unit 216 conforms to the Bluetooth® wireless specification, which defines the link layer and application layer for product developers. In the illustrative example, antenna 214 transmits both the voice and short range transmissions.

Liquid crystal display (LCD) 218 provides a display for pictures and other data for wireless mobile device 200. Camera 220, in this example, is a complementary metal oxide semiconductor (CMOS) camera which can be built into wireless mobile device 200 or connected to wireless mobile device 200 as a module, such as IC card 222. IC card 222 also may contain other application specific functions, such as a global positioning system (GPS) or other functions, such as a modem or additional memory.

The illustrative embodiments provide a method and an apparatus for writing a shortened text message using the apparatus. In these examples, the apparatus takes the form of a wireless mobile device. However, the illustrative embodiments are not limited to a wireless mobile device. The apparatus can take any other form, including but not limited to a personal digital assistant (PDA) or a computer.

In the illustrative embodiments, a user is given the option of writing a message on a wireless mobile device in a shortened form. In response to the user choosing to write the message in a shortened form, an editor receives longhand text written through a user interface for the wireless mobile device. The editor then matches the longhand text with at least one shortened equivalent. A user interface then displays the at least one shortened equivalent to the user. The user interface instantaneously displays the at least one shortened equivalent to the user as the user writes the longhand text. In response to receiving a user input accepting the at least one shortened equivalent through the user interface, the editor replaces the longhand text in a message with the at least one shortened equivalent.

In one embodiment, the wireless mobile device includes a predictive text feature. The user has the option of activating or deactivating the predictive text feature. The predictive text feature anticipates the end of partially written longhand text to form a predicted text. The predictive text feature then matches the predicted text with an at least one shortened equivalent. In one embodiment, the user interface then displays the at least one shortened equivalent to the user. In another embodiment, the user interface displays the predicted text. Then, the user has the option of accepting or declining the predicted text. If the user accepts the predicted text, the editor replaces the partially written longhand text with the predicted text. A user is then given an option to write a shortened text message using at least one of the shortened equivalents for the predicted text.

In the illustrative embodiments, the wireless mobile device allows a user to modify the database. The user modifies the database by at least one of adding a first set of longhand text and at least one corresponding shortened equivalent, removing a second set of longhand text and at least one corresponding shortened equivalent, adding at least one alternative shortened equivalent, removing at least one shortened equivalent, or replacing at least one shortened equivalent.

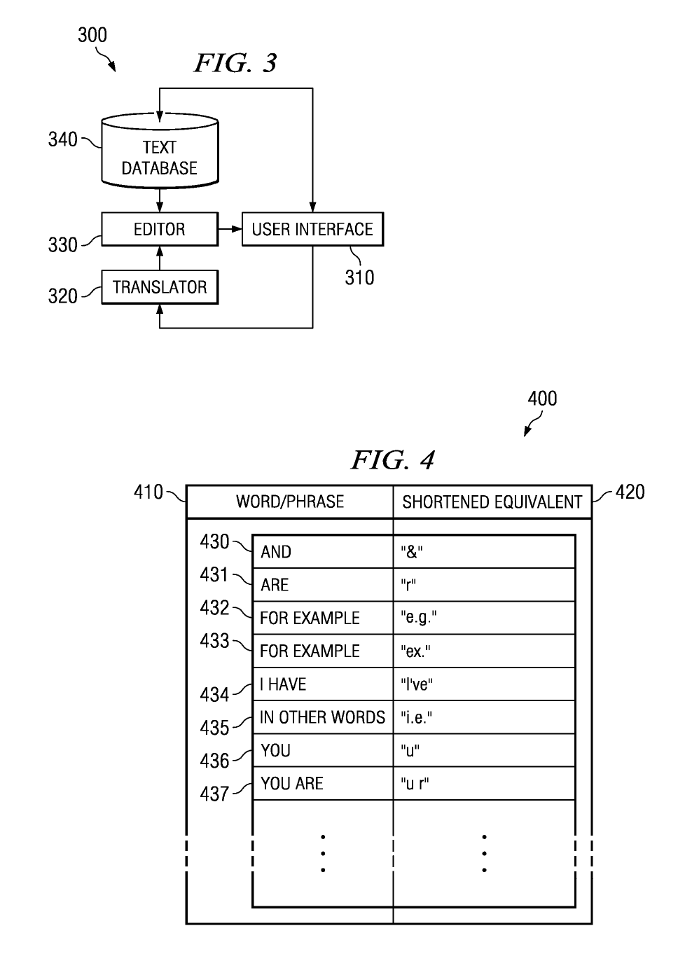

FIG. 3 is a block diagram of a text messaging system of a wireless mobile device, in accordance with an illustrative embodiment. Wireless mobile device 300 is similar to wireless mobile device 100 of FIG. 1 and wireless mobile device 200 of FIG. 2. Wireless mobile device 300 includes user interface 310, translator 320, editor 330, and text database 340. In the illustrative embodiment, wireless mobile device 300 is implemented as an embodiment containing both hardware and software components. However, in another embodiment, wireless mobile device 300 can also be implemented as an entirely software embodiment or as an entirely hardware embodiment.

User interface 310 can be implemented as screen 102 of FIG. 1 or LCD 218 of FIG. 2. In the illustrative embodiment, user interface 310 connects to a keypad, similar to numeric keypad 104 of FIG. 1. A user uses the keypad to type or write a text message. User interface 310 displays the text message as the user writes the message.

Translator 320 connects to user interface 310 and is implemented in an application processor, similar to application processor 204 of FIG. 2. Translator 320 converts written text into a form that is readable by wireless mobile device 300. Typically, translator 320 converts the text into binary form. For example, translator 320 converts the letter “A” into the binary form “01000001”. Likewise, in another example, translator 320 converts the number “4” into the binary form “00000100”. Translator 320 transmits the converted text to editor 330.

In these examples, editor 330 converts a longhand text into a shortened text. Editor 330 is implemented in the application processor of wireless mobile device 300. Longhand text is text written in full form and can be either a single word or a group of words, such as a phrase. Shortened text is the shortened equivalent of the longhand text. The shortened equivalent can be a letter, number, symbol, or any combination thereof.

Editor 330 obtains the shortened equivalents from text database 340. Text database 340 is a storage device and can be implemented as flash/SRAM, such as flash/SRAM 206 of FIG. 2, or a flash card, such as flash card 208 of FIG. 2. In the illustrative embodiment, text database 340 is coupled to editor 330. However, in another embodiment, text database 340 can be implemented as a separate database accessible to editor 330 via a network connection. The network connection can be implemented as the Internet, which is a worldwide collection of networks and gateways that use the Transmission Control Protocol/Internet Protocol (TCP/IP) suite of protocols to communicate with one another.

Text database 340 is a data management system that can store and execute instructions against the stored data. Text database 340 stores data in a storage device, similar to flash/SRAM 206 or flash card 208 of FIG. 2. Text database 340 can store data in any format, including but not limited to a table, a flat file, an Extensible Markup Language (XML) file, a relational database management system, or any combination thereof. Text database 340 can also be implemented in the application processor, similar to application processor 204 of FIG. 2, for wireless mobile device 300. Thus, text database 340 executes instructions against the data stored in text database 340. In the illustrative embodiment, text database 340 stores data in a table and executes instructions against the data stored in the table.

Text database 340 can be a default database or a user-modified database. In the default database, text database 340 includes a list of words and phrases that are commonly known abbreviations or symbols for the longhand text. For example, the default database can include “corp” as the shortened equivalent for the longhand text “corporation” and “&” as the shortened equivalent for the longhand text “and”. The default database also includes shortened equivalents commonly used in text messaging. For example, the database can include “b4” as the shortened equivalent for the longhand text “before” and “u r” as the shortened equivalent for the longhand text “you are”.

A user can also modify the default database by adding or deleting data in the default database. In one embodiment, the user creates a completely new longhand text and corresponding shortened equivalent set. In another embodiment, the user only adds a shortened equivalent to an existing longhand text. In yet another embodiment, the user deletes or removes the longhand text and corresponding shortened equivalent set. The user can implement one or more of the described embodiments when modifying the default database.

In the illustrative embodiment, text database 340 stores a list of longhand text with its corresponding shortened equivalent. The list is alphabetized and sorted in a lexicographical order, which is the conventional order of letters in an alphabet. In the illustrative embodiment, text database 340 executes an instruction to sort the data stored in text database 340 alphabetically by the longhand text. In executing the instruction, the database compares each nth letter against the nth letter of other words in the list, starting at the first letter of each word and advancing to the second letter, third letter, fourth letter, and so on, until the entire list is alphabetized in the lexicographical order. If more than one shortened equivalent exists for a single longhand text, a similar instruction is executed that organizes the shortened equivalents within each longhand text in lexicographical order.

When a new entry is added, text database 340 inserts the entry into the appropriate alphabetical location. If the new entry is an entirely new set of longhand text with a corresponding shortened equivalent, then the entire new set is inserted into the appropriate alphabetical location. If the new entry is a new shortened equivalent, text database 340 locates the specific longhand text. Text database 340 then copies the specific longhand text and creates a new set of longhand text and the new shortened equivalent. The entire set is then inserted into the appropriate alphabetical location.

In use, a user writes a longhand message using a numerical keypad connected to user interface 310. Each time the user types in a letter, user interface 310 transmits the letter to translator 320. Translator 320 then converts the letter into binary form and transmits the letter to editor 330. Editor 330 reads the converted letter and awaits transmittal of the next converted letter. Editor 330 strings together each converted letter until a complete word is formed. A “space” between the letters identifies the next word, and editor 330 determines the beginning and the end of a word based on the “space” at each end.

After editor 330 receives the first converted letter, editor 330 accesses the list of longhand text in text database 340. Editor 330 matches the first converted letter with the first letter of the words in the list of longhand text. For example, in the illustrative embodiment, if the first converted letter received by editor 330 is an “A”, then editor 330 locates all the words and phrases in the list of longhand text that begin with the letter “A”.

Editor 330 continues to match each additional letter as subsequent converted letters are received. Thus, continuing with the illustrative example, if the second letter is “r”, then editor 330 locates all words and phrases that begin with the combined letters “ar”. When an entire converted word is matched with a longhand text entry, editor 330 extracts the corresponding shortened equivalent from the table in text database 340. Editor 330 then transmits the shortened equivalent to user interface 310. User interface 310 instantaneously displays the shortened equivalent to the user.

Instantaneously, as used herein, is any time period before a user begins to write another word or before the user completes the entire text message. A text message is completed when the user transmits the text message to another user or when the user initializes the “send” message feature. Therefore, in the illustrative embodiment, user interface 310 instantaneously displays the shortened equivalent by displaying the shortened equivalent prior to the user starting to write a subsequent word in the text message.

In the illustrative embodiment, the user has the option of accepting or declining the shortened equivalent. If the user accepts the shortened equivalent, then editor 330 replaces the longhand text with the shortened equivalent. To replace, editor 330 first identifies the beginning of the longhand text by locating the “space” before the longhand text. After locating the “space”, editor 330 deletes all characters after the “space”. Editor 330 then replaces the deleted longhand text with the shortened equivalent.

If, in an alternative embodiment, the longhand text includes more than one shortened equivalent, editor 330 extracts all the shortened equivalents from text database 340. Editor 330 then transmits all the shortened equivalents to user interface 310. User interface 310 displays all the shortened equivalents to the user and instructs the user to choose which shortened equivalent to use in the text message.

If the longhand text is a group of words or a phrase instead of a single word, editor 330 implements a similar process for identifying the phrase in text database 340. For example, in the illustrative embodiment, if user interface 310 presents the word “are”, then editor 330 locates the word in text database 340. Editor 330 identifies the word as part of a possible phrase because text database 340 includes the longhand text “are” followed by another word. As a result, editor 330 waits for interface 310 to present the subsequent word before displaying the shortened equivalent to the user.

In a similar manner, editor 330 replaces the longhand text if the longhand text is a phrase by identifying the “space” before the first word of the longhand text. For example, if the phrase “you are” is being replaced with a shortened equivalent, then editor 330 locates the “space” before the word “you”, deletes the entire phrase “you are”, and then replaces the longhand text with the shortened equivalent “u r”.

In another embodiment, editor 330 also includes a predictive text feature. The predictive text feature anticipates the end of partially written longhand text. Thus, in the illustrative embodiment, as a user writes the longhand text in a text message, editor 330 presents a list of all the words that match the partially written longhand text. For example, if the user begins the longhand text with “ar”, then editor 330 identifies all words and phrases that begin with “ar”. Editor 330 then displays all the words and phrases from text database 340 that begin with “ar” to the user on user interface 310. The user then has the option of choosing one of the words or phrases in the list or continuing to write the longhand text. As the user types each additional letter into the longhand text, editor 330 repeats the process of reading the additional letter, locating all the words and phrases that begin with the partially written word, and presenting the list to the user. The user can select one of the displayed words or phrases at any time while the user is writing the word or phrase, or the user can select the word or phrase when the user completes the entire longhand text.

In the illustrative embodiment, the predictive text feature begins once the user writes the first letter of a word. Thus, continuing with the illustrative example, the predictive text feature would begin locating and displaying all words and phrases that begin with the letter “a”. However, in an alternative embodiment, editor 330 can begin displaying the list of words and phrases after the user types a certain number of letters in a word. For example, editor 330 can begin displaying words and phrases after the user writes the second or third letter in the word. The point at which the predictive text feature displays the list of words and phrases can be a default feature or can be specified by the user as a user preference. In the illustrative embodiment, the predictive text feature is set by the user as a user preference, and the predictive text feature begins displaying words and phrases after the user writes the second letter in a word.

In an alternative embodiment, editor 330 displays only a list of shortened equivalents to the user. In the embodiment, the predictive text feature still anticipates the end of a partially written longhand text. But, instead of listing the anticipated word or phrase, editor 330 extracts and transmits only the shortened equivalent to user interface 310.

In another embodiment, the predictive text feature is optional. The user can activate and deactivate the predictive text feature. In yet another embodiment, text database 340 also includes a dictionary for use with the predictive text feature. In this embodiment, text database 340 transmits a list of all the words in the dictionary that begin with the partially written longhand text. User interface 310 displays the entire list to the user so that the user can select a word or phrase from the entire list. In still yet another embodiment, text database 340 extracts and transmits only the first word or phrase in the alphabetized list that matches the partially written longhand text.

FIG. 4 illustrates an example of a database, in accordance with an illustrative embodiment. Table 400 can be implemented in a database, such as database 310 of FIG. 3.

Table 400 includes word/phrase column 410 and shortened equivalent column 420. Word/phrase column 410 lists the full version of a word or, in other words, the longhand text. Shortened equivalent column 420 is the corresponding shortened equivalent of the word or phrase listed in word/phrase column 410.

The data in table 400 can be a default database or a database modified by a user. The default database includes words and phrases with commonly known abbreviations or symbols that represent the respective word or phrase. A user can also modify the default database by adding or removing data from word/phrase column 410 and shortened equivalent column 420.

The data in table 400 is stored and listed in alphabetical order according to word/phrase column 410. If a word or phrase in column 410 has more than one shortened equivalent, the shortened equivalent in shortened equivalent column 420 is also alphabetized.

In the illustrative embodiment, word/phrase column 410 illustrates eight examples of longhand text with corresponding shorthand equivalents. In row 430, the word “and” has a shortened equivalent of “&”. In row 431, the word “are” has a shortened equivalent of “r”.

“For example” in rows 432 and 433 has two different shortened equivalents: “e.g.” and “ex.”. Row 432 includes “e.g.” while row 433 includes “ex.”. In the illustrative embodiment, each shortened equivalent for “for example” is listed in a different row. However, in an alternative embodiment, “for example” can list both shortened equivalents in a single row.

In row 434, the phrase “I have” has a shortened equivalent of “I've”. In row 435, the phrase “in other words” has a shortened equivalent of “i.e.”. In row 436, the word “you” has the shortened equivalent of “u”. In row 437, the phrase “you are” has the shortened equivalent of “u r”.

Table 400 is not limited to the illustrative embodiment. For example, table 400 may include more or fewer rows and columns. Additionally, table 400 may have a number of columns similar to word/phrase column 410 when a shortened equivalent has more than one corresponding word or phrase. For example, “i.e.” can also be the shortened equivalent for the phrase “that is” or “in this case”. In another example, “etc.” can be the shortened equivalent for the phrase “and the rest”, “and so on”, or “and more”. Thus, in another embodiment, table 400 can include a number of word/phrase columns 410.

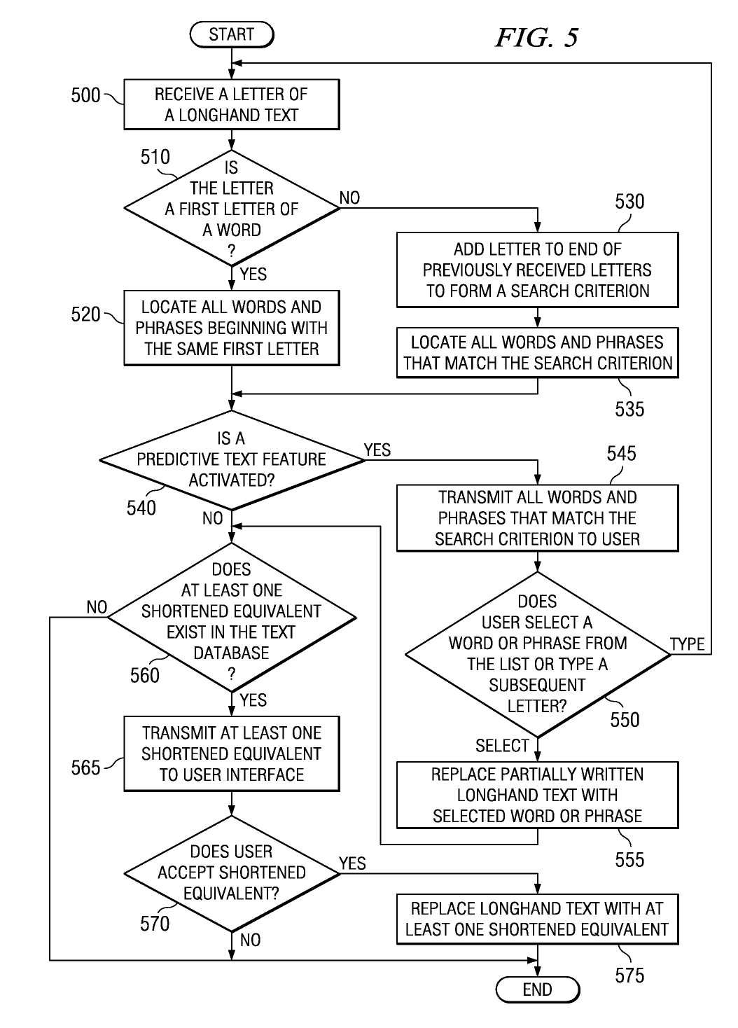

FIG. 5 is a flowchart illustrating the process of writing a shortened text message, in accordance with an illustrative embodiment. The following process is exemplary only and the order of the steps may be interchanged without deviating from the scope of the invention. The process is executed in an editor, similar to editor 330 of FIG. 3.

The process begins with an editor receiving a letter of a longhand text (step 500). A determination is then made as to whether the letter is a first letter of a word (step 510). A letter is a first letter of a word if the letter is preceded by a space or begins a new message. If the letter is a first letter of a word (“yes” output to step 510), then the editor locates all words and phrases that begin with the same first letter (step 520). To locate the words and phrases, the editor forms a search criterion. In the illustrative embodiment, the search criterion is a command to locate all words and phrases that begin with the same first letter.

Returning to step 510, if the letter is not a first letter of a word (“no” output to step 510), then the editor adds the letter to the end of any previously received letters (step 530). The addition of the letter to the end of any previously received letters forms a search criterion. The search criterion is then any word or phrase that matches all the previously received letters plus the currently added letter. The editor then locates all words and phrases that match the search criterion (step 535).

Returning to steps 520 and 535, a determination is then made as to whether a predictive text feature is activated (step 540). If the predictive text feature is activated (“yes” output to step 540), then the editor transmits all words and phrases that match the search criterion to the user (step 545). The words and phrases are displayed as a scrollable list to the user.

A determination is then made as to whether a user selected a word or phrase from the presented list or typed a subsequent letter in the longhand text (step 550). If the user typed a subsequent letter (“type” output to step 550), the process returns to step 500. However, if the user selected a word or phrase from the list (“select” output to step 550), the editor replaces the partially written longhand text with the selected word or phrase (step 555). A determination is then made as to whether at least one shortened equivalent exists in the text database (step 560). If at least one shortened equivalent does not exist (“no” output to step 560), the process terminates thereafter.

Returning to step 540, if the predictive text feature is not activated (“no” output to step 540), a determination is then made as to whether at least one shortened equivalent exists in the database (step 560). If at least one shortened equivalent does not exist (“no” output to step 560), the process terminates thereafter. If at least one shortened equivalent exists (“yes” output to step 560), then the editor transmits the at least one shortened equivalent to the user interface (step 565). A determination is then made as to whether the user accepts the shortened equivalent (step 570). If the user does not accept the shortened equivalent (“no” output to step 570), then the longhand text is used in the text message and the process terminates thereafter.

Returning to step 570, if the user accepts the shortened equivalent (“yes” output to step 570), then the editor replaces the longhand text with the at least one shortened equivalent (step 575). The process terminates thereafter.

The illustrative embodiments provide a method and an apparatus for writing a shortened text message using the apparatus. In these examples, the apparatus takes the form of a wireless mobile device. However, the illustrative embodiments are not limited to a wireless mobile device. The apparatus can take any other form, including but not limited to a personal digital assistant (PDA) or a computer.

In the illustrative embodiments, a user is given the option to write a message on a wireless mobile device in a shortened form. In response to the user choosing to write the message in a shortened form, an editor receives longhand text written through a user interface for the wireless mobile device. The editor then matches the longhand text with at least one shortened equivalent. A user interface then displays the at least one shortened equivalent to the user. The user interface instantaneously displays the at least one shortened equivalent to the user as the user writes the longhand text. In response to receiving a user input accepting the at least one shortened equivalent through the user interface, the editor replaces the longhand text in a message with the at least one shortened equivalent.

A user is given the option of writing a message on a wireless mobile device in a shortened form. In response to the user choosing to write the message in a shortened form, an editor receives longhand text written by the user. The editor then matches the longhand text with at least one shortened equivalent. A user interface then displays the at least one shortened equivalent to the user. The user interface instantaneously displays the at least one shortened equivalent to the user as the user writes the longhand text. In response to receiving an acknowledgment from the user to accept the at least one shortened equivalent, the editor replaces the longhand text in a message with the at least one shortened equivalent.

In one embodiment, the wireless mobile device includes a predictive text feature. The user has the option of activating or deactivating the predictive text feature. The predictive text feature anticipates the end of partially written longhand text to form a predicted text. The predictive text feature then matches the predicted text with at least one shortened equivalent. In one embodiment, the user interface then displays the at least one shortened equivalent to the user. In another embodiment, the user interface displays the predicted text, and the user has the option of accepting or declining the predicted text. If the user accepts the predicted text, the editor replaces the partially written longhand text with the predicted text. The user is then given an option to write a shortened text message using the predicted text.

In the illustrative embodiments, the wireless mobile device allows a user to modify the database. The user modifies the database by at least one of adding a first set of longhand text and at least one corresponding shortened equivalent, removing a second set of longhand text and at least one corresponding shortened equivalent, adding at least one alternative shortened equivalent, removing at least one shortened equivalent, and replacing at least one shortened equivalent.

The illustrative embodiments provide a method and wireless mobile device for creating a shortened text message. The illustrative embodiments allow a user to use a database of shortened text rather than relying on the user's own memory to recall the shortened text. Additionally, the illustrative embodiments provide a user with the means to record additional shortened texts that a user may receive in a message from another user. Furthermore, the illustrative embodiments provide a predictive text feature that anticipates the end of a word and presents the shortened equivalent to the word.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer-readable medium can be any tangible apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modems and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method for writing a shortened text message using a wireless mobile device, the method comprising:
receiving longhand text written through a user interface for the wireless mobile device;
matching the longhand text with at least one shortened equivalent;
displaying the at least one shortened equivalent; and
responsive to receiving a user input accepting the at least one shortened equivalent through the user interface, replacing the longhand text with the at least one shortened equivalent.

2. The method of claim 1, wherein the at least one shortened equivalent is displayed instantaneously on the user interface the longhand text is being written.

3. The method of claim 1, further comprising:
providing an option to a user to write the shortened text message.

4. The method of claim 1, wherein the step of receiving a user input accepting the at least one shortened equivalent through the user interface further comprises:
allowing a user to modify the database by at least one of adding a first set of longhand text and at least one corresponding shortened equivalent, removing a second set of longhand text and at least one corresponding shortened equivalent, adding at least one alternative shortened equivalent, removing at least one shortened equivalent, and replacing at least one shortened equivalent.

5. The method of claim 1, further comprising:
anticipating an end of partially written longhand text to form predicted text; and
matching the predicted text with at least one shortened equivalent.

6. The method of claim 5, further comprising:
displaying instantaneously the predicted text on the user interface as the partially written longhand text is being written; and
responsive to receiving a user input accepting the predicted text through the user interface, replacing the partially written longhand text with the predicted text.

7. The method of claim 5, further comprising:
providing an option to a user to activate a predicted text feature.

8. A wireless mobile device comprising:
a database comprising at least one shortened equivalent for a longhand text;
an editor connected to the database, wherein the editor receives the longhand text written through a user interface for the wireless mobile device, and wherein the editor matches the longhand text with the at least one shortened equivalent; and
a user interface connected to the editor, wherein the user writes the longhand text using the user interface, and wherein the user interface displays the at least one shortened equivalent, and wherein the editor replaces the longhand text with the at least one shortened equivalent in response to receiving a user input accepting the at least one shortened equivalent through the user interface.

9. The apparatus of claim 8, wherein the user interface instantaneously displays at least one shortened equivalent is as the longhand text is being written.

10. The apparatus of claim 8, wherein the editor provides the user with an option to write a shortened text message.

11. The apparatus of claim 8, wherein the editor allows the user to modify the database by at least one of adding a first set of longhand text and at least one corresponding shortened equivalent, removing a second set of longhand text and at least one corresponding shortened equivalent, adding at least one alternative shortened equivalent, removing at least one shortened equivalent, and replacing at least one shortened equivalent.

12. The apparatus of claim 8, wherein the editor comprises a predictive text feature, and wherein the predictive text feature anticipates an end of partially written longhand text to form predicted text, and wherein the predictive text feature matches the predicted text with the at least one shortened equivalent.

13. The apparatus of claim 12, wherein the user interface instantaneously displays the predicted text as the partially written longhand text is being written, and wherein the predictive text feature replaces the partially written longhand text with the predicted text.

14. The apparatus of claim 12, wherein the editor provides the user with an option to activate a predicted text feature.
